(19) United States
(12) Patent Application Publication
(10) Pub. No.: US 2006/0232718 A1
(43) Pub. Date: Oct. 19, 2006

(54) Display apparatus

(76) Inventor: Chen-Sung Liao, Taichung City (TW)

Correspondence Address: BLISS McGLYNN P.C., SUITE 600, 2075 WEST BIG BEAVER ROAD, TROY, MI, 48084, US

(21) Appl. No.: 11/368,877

(22) Filed: Mar. 6, 2006

(30) Foreign Application Priority Data
Apr. 14, 2005 (TW) 094205839

(51) Int. Cl. H04N 5/65

(52) U.S. Cl. 348/818

(57) ABSTRACT

A display apparatus includes a display housing, a mounting device, and an optical instrument. The mounting device includes an outer frame unit disposed in the display housing, and an inner frame unit coupled slidably to the outer frame unit, and movable relative to the outer frame unit between a first position, where the inner frame unit is disposed in the outer frame unit, and a second position, where the inner frame unit is extended out of the outer frame unit. The optical instrument is mounted on the inner frame unit of the mounting device.

### BACKGROUND OF THE INVENTION

1. Field of the Invention

The invention relates to a display apparatus, more particularly to a display apparatus that includes a mounting device to provide easy access to an optical instrument.

2. Description of the Related Art

As shown in FIG. 1, a conventional display apparatus 2 includes a display housing 20, a mounting platform 21 disposed in and secured to the display housing 20, an optical instrument 23 mounted on the mounting platform 21, and a display screen 22 mounted on the display housing 20.

In order to ensure accurate projection of source light onto the display screen 22, it is required for the optical instrument 23 to be positioned precisely. However, once the optical instrument 23 is mounted on the mounting platform 21, the position thereof cannot be adjusted. As a result, it is required to repeat the mounting-dismounting procedure until the optical instrument 23 is at its desired position. Since the optical instrument 23 is disposed in the display housing 20, other components disposed in the display housing 20, in addition to the limited space available in the display housing 20, interfere with mounting and dismounting of the optical instrument 23. This is not only inconvenient and troublesome, but is also time-consuming.

### SUMMARY OF THE INVENTION

Therefore, the object of the present invention is to provide a display apparatus that facilitates easy access to an optical instrument such that adjustments to the optical instrument can be easily performed.

According to the present invention, there is provided a display apparatus that includes a display housing, a mounting device, and an optical instrument. The mounting device includes an outer frame unit disposed in the display housing, and an inner frame unit coupled slidably to the outer frame unit, and movable relative to the outer frame unit between a first position, where the inner frame unit is disposed in the outer frame unit, and a second position, where the inner frame unit is extended out of the outer frame unit. The optical instrument is mounted on the inner frame unit of the mounting device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional display apparatus;

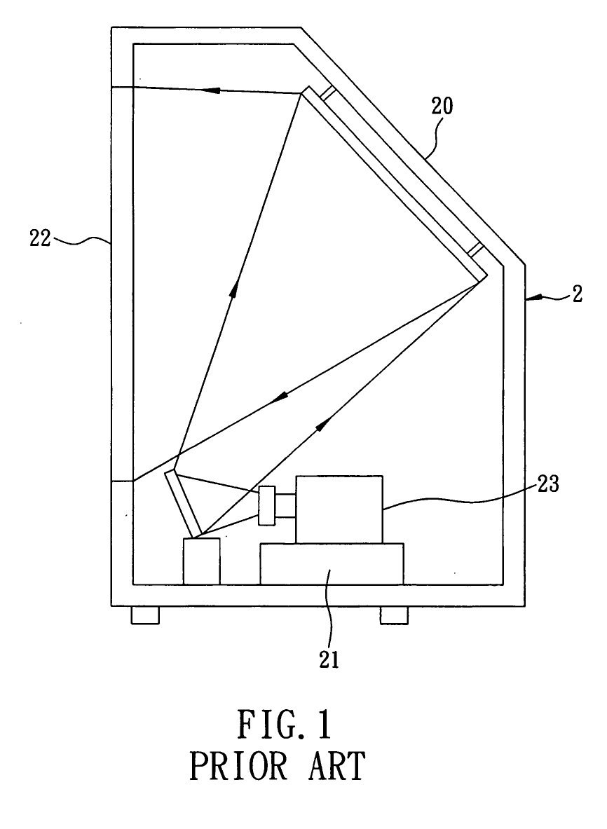

FIG. 2 is a schematic view of the preferred embodiment of a display apparatus according to the present invention;

FIG. 3 is a perspective view of a mounting device according to the preferred embodiment, illustrating an inner frame unit disposed at a first position;

FIG. 4 is a perspective view of the mounting device according to the preferred embodiment, illustrating the inner frame unit disposed at a second position; and

FIG. 5 is a schematic side view of the preferred embodiment with the inner frame unit disposed at the second position.

### DETAILED DESCRIPTION OF THE PREFERRED EMBODIMENT

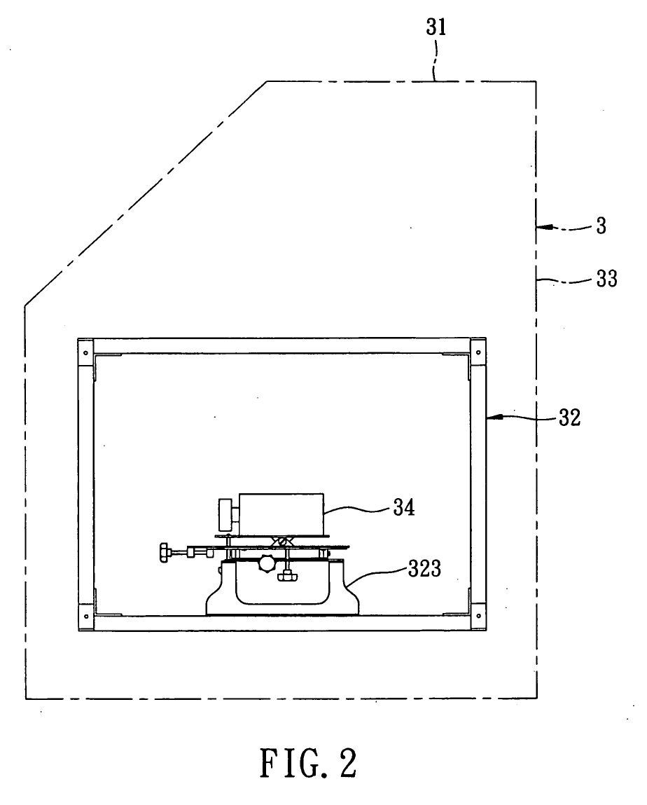

As shown in FIG. 2, the preferred embodiment of a display apparatus 3 according to the present invention includes a display housing 31, amounting device 32, a display screen 33 mounted on one side of the display housing 31, and an optical instrument 34.

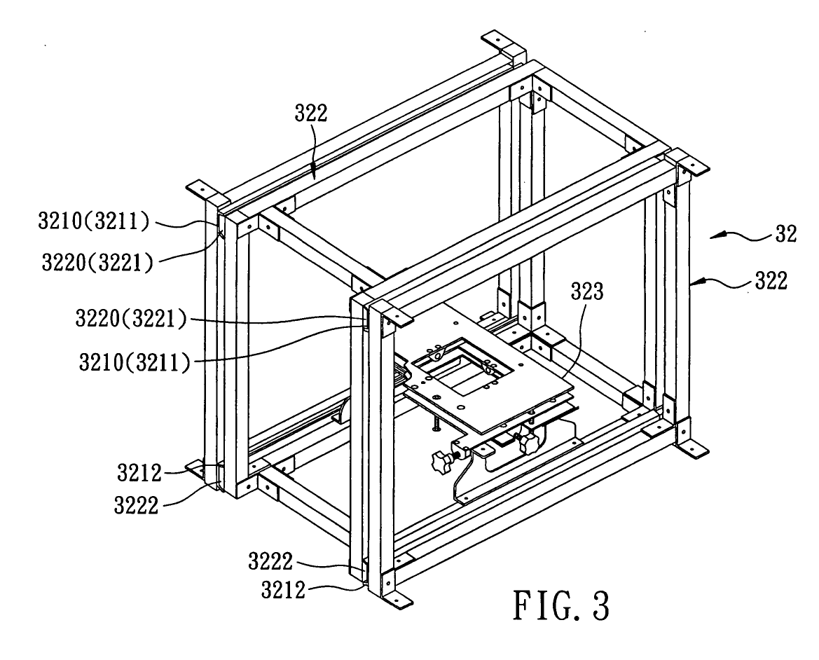

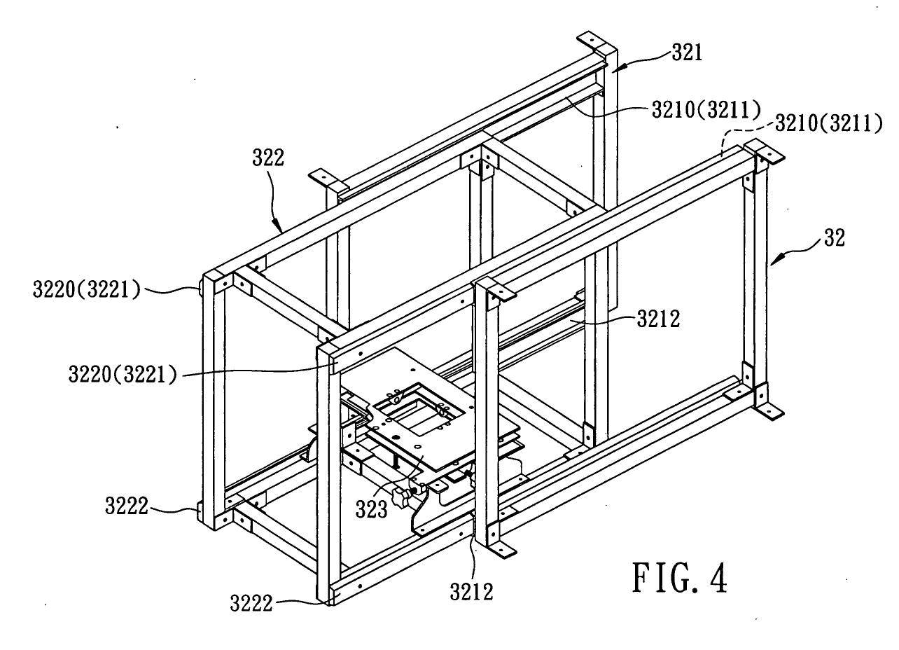

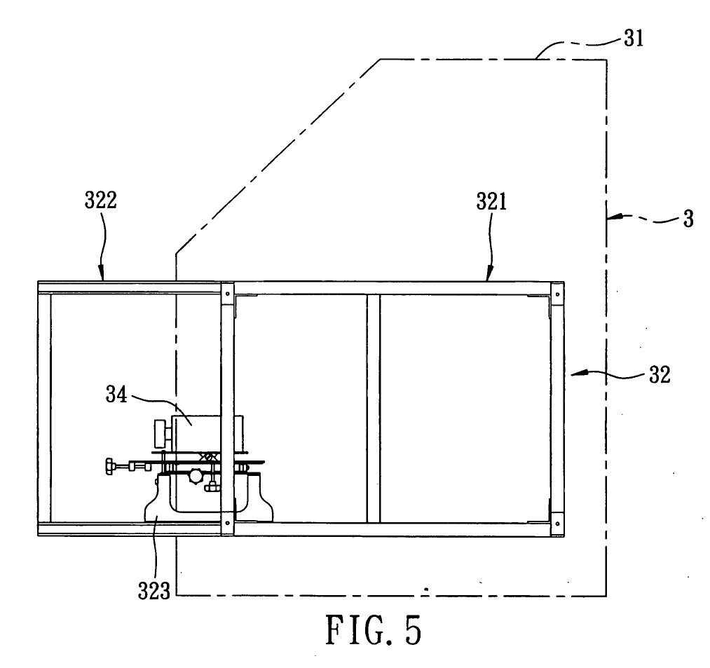

As shown in FIG. 3, the mounting device 32 includes an outer frame unit 321, an inner frame unit 322, and an adjustable mounting seat 323. The outer frame unit 321 is disposed in the display housing 31. The inner frame unit 322 is hollow on all sides thereof, is coupled slidably to the outer frame unit 321, and is movable relative to the outer frame unit 321 between first and second positions. As best illustrated in FIG. 2 and FIG. 3, the inner frame unit 322 is disposed in the outer frame unit 321 when the inner frame unit 322 is at the first position. As best illustrated in FIG. 4 and FIG. 5, the inner frame unit 322 is extended out of the outer frame unit 321 when the inner frame unit 322 is at the second position. In this embodiment, the display housing 31 is configured to permit the inner frame unit 322 to extend outwardly of the display housing 31 when the inner frame unit 322 is moved to the second position. The adjustable mounting seat 323 is mounted on the inner frame unit 322.

Referring back to FIG. 2, the optical instrument 34 is mounted on the adjustable mounting seat 323 such that the optical instrument 34 is movable along with the inner frame unit 322 relative to the outer frame unit 321 between the first and second positions, respectively illustrated in FIGS. 2-3 and FIGS. 4-5. The adjustable mounting seat 323 facilitates adjustments to the location of the optical instrument 34 once the optical instrument 34 is mounted thereon. Details of the adjustable mounting seat 323 are disclosed in co-pending U.S. patent application Ser. No. ______ entitled “ADJUSTABLE MOUNTING DEVICE”, filed on Jan. ______, 2006. Since the feature of the present invention does not reside in the adjustable mounting seat 323, further details of the same will be omitted herein.

The outer frame unit 321 of the mounting device 32 is provided with a first rail part 3210, while the inner frame unit 322 is provided with a second rail part 3220 that engages the first rail part 3210 such that the inner frame unit 322 is movable relative to the outer frame unit 321. More particularly, in this embodiment, the outer frame unit 321 includes a pair of first upper rail parts 3211 spaced apart from each other, and a pair of first lower rail parts 3212 spaced apart from each other. The inner frame unit 322 includes a pair of second upper rail parts 3221 spaced apart from each other and engaging movably and respectively the first upper rail parts 3211, and a pair of second lower rail parts 3222 spaced apart from each other and engaging movably and respectively the first lower rail parts 3212.

Since the inner frame unit 322 extends out of the display housing 31 at the second position (as shown in FIGS. 4-5), and since all sides of the inner frame unit 322 are hollow, a user (not shown) can have easy access to the optical instrument 34 when adjustments to the location thereof are needed. Due to the presence of the adjustable mounting seat 323 of the mounting device 32, adjustments to the location of the optical instrument 34 can be easily performed without removing the optical instrument 34 from the mounting device 32. When adjustments to the location of the optical instrument 34 are completed, the inner frame unit 322 only needs to be moved back to the first position (as shown in FIGS. 2-3) so as to be securely disposed inside the display housing 31 such that source light can be accurately projected to the display screen 33.

In sum, by having the slidable coupling between the outer and inner frame units 321, 322 of the mounting device 32, the display apparatus 3 according to the present invention has the advantage in which adjustments to the position of the optical instrument 34 can be easily performed since there is much space available outside the display housing 31, and since other components of the display apparatus 3 that are disposed in the display housing 31 can no longer interfere with the adjustments.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A display apparatus comprising:
a display housing;
a mounting device including
an outer frame unit disposed in said display housing, and
an inner frame unit coupled slidably to said outer frame unit, and movable relative to said outer frame unit between a first position, where said inner frame unit is disposed in said outer frame unit, and a second position, where said inner frame unit is extended out of said outer frame unit; and
an optical instrument mounted on said inner frame unit of said mounting device.

2. The display apparatus as claimed in claim 1, wherein said outer frame unit of said mounting device is provided with a first rail part, said inner frame unit of said mounting device being provided with a second rail part that engages said first rail part such that said inner frame unit is movable relative to said outer frame unit.

3. The display apparatus as claimed in claim 1, wherein:
said outer frame unit of said mounting device includes a pair of first upper rail parts spaced apart from each other, and a pair of first lower rail parts spaced apart from each other; and
said inner frame unit of said mounting device is hollow on all sides thereof, and includes a pair of second upper rail parts spaced apart from each other and engaging movably and respectively said first upper rail parts, and a pair of second lower rail parts spaced apart from each other and engaging movably and respectively said first lower rail parts.

4. The display apparatus as claimed in claim 1, wherein said display housing is configured to permit said inner frame unit to extend outwardly of said display housing when said inner frame unit is moved to the second position.

5. The display apparatus as claimed in claim 1, further comprising a display screen mounted on said display housing.
